(19) United States
(12) Patent Application Publication
(10) Pub. No.: US 2012/0215477 A1
(43) Pub. Date: Aug. 23, 2012

(54) Accelerometer and Automatic Calibration of Same

(75) Inventors: Kimberly L. Tuck, Austin, TX (US); Rodrigo L. Borras, Marshalltown, IA (US)

(73) Assignee: Freescale Semiconductor, Inc., Austin, TX (US)

(21) Appl. No.: 13/031,545

(22) Filed: Feb. 21, 2011

(51) Int. Cl. G01K 15/00; G01P 15/00; G06F 15/00; G01P 21/00

(52) U.S. Cl. 702/99; 73/1.38; 702/141; 702/104

(57) ABSTRACT

An accelerometer (22) includes sense elements (24, 26, 28) for measuring acceleration (30, 32, 34) and a processor (36) in communication with the sense elements (24, 26, 28). The processor (36) executes an auto-calibration process (46) that entails collecting (94) acceleration datasets (96) and identifying a subset (130) of acceleration datasets (132) in which each of the acceleration datasets (132) represents a scenario in which the accelerometer (22) is in a static position and in which the acceleration datasets (132) represent a variety of orientations of the accelerometer (22). The subset (130) of acceleration datasets (132) is utilized to compute updated calibration parameters (184). Current calibration parameters (48) are compared to the updated parameters (184) to determine validity of the current parameters (48). When the current parameters (48) are invalid, they are replaced with the updated parameters (184), and the updated parameters (184) are implemented to calibrate the accelerometer (22).

### TECHNICAL FIELD OF THE INVENTION

The present invention relates generally to the calibration of inertial sensors. More specifically, the present invention relates to an accelerometer capable of automatic calibration during operational use.

### BACKGROUND OF THE INVENTION

An accelerometer is a device that typically measures the acceleration experienced relative to freefall. Single- and multi-axis accelerometers are available to detect magnitude and direction of the acceleration as a vector quantity, and can be used to sense orientation, acceleration, vibration shock, and falling. Micromachined accelerometers are increasingly present in portable electronic devices and video game controllers to detect the position of the device and/or provide for game input.

Various sources of error in an accelerometer typically call for calibration before use. One of the leading sources of error in an accelerometer is attributed to the 0g-offset or bias error. The 0g-offset is defined as the difference between the measured value of the sensor from the true zero value. The 0g-offset value is commonly subtracted off when taking acceleration measurements. Accelerometers are typically calibrated by the semiconductor manufacturer prior to their installation into another device. For example, accelerometers are “trimmed” for 0g-offset and sensitivity by adjusting the offset trim codes and gain.

Even though accelerometers are calibrated by the semiconductor manufacturer, they tend to lose their calibration. For example, when the accelerometers are mounted onto a printed circuit board, various mechanical strains are produced. These mechanical strains can be produced on the package from mounting the part to the PCB, from the PCB mount holes or screws, from other components placed close to the sensor, and so forth. Such conditions can cause further 0g-offset or shifts. Other conditions can cause further 0g-offset or shifts, such as temperature changes and long-term drift effects due to aging. These sources of error can cause the accelerometer to appear to be tilted or rotated relative to a zero reference point. Thus, re-calibration after the sensor has been mounted and/or incorporated into a device may be needed to improve the measurement accuracy of the accelerometer.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of a device having an auto-calibrating accelerometer installed therein in accordance with an embodiment;

FIG. 2 shows a diagram of calibration values used to determine calibration parameters for the accelerometer of FIG. 1;

FIG. 3 shows a flowchart of an auto-calibration process performed by the accelerometer of FIG. 1;

FIG. 4 shows a flowchart of a static position recognition subprocess implemented within the auto-calibration process;

FIG. 5 shows a flowchart of an orientation selection subprocess implemented within the auto-calibration process;

FIG. 6 shows a table of an exemplary acceleration dataset buffer;

FIG. 7 shows a diagram of equations for computing a magnitude of acceleration vector;

FIG. 8 shows a diagram of equations for computing the resulting error of a set of estimated parameters; and

FIG. 9 shows a table of calibration parameters associated with particular operational temperature ranges for the accelerometer.

### DETAILED DESCRIPTION

Embodiments of the present disclosure entail an accelerometer capable of autonomous calibration and a method performed by the accelerometer for updating calibration parameters of the accelerometer. Prior art devices and methodologies entail manual calibration, or re-calibration, of an accelerometer. Such manual calibration is cumbersome, costly, and interferes with the normal operation of the accelerometer. Embodiments of the disclosure described herein allow for calibration of an accelerometer to occur without user intervention. This methodology can therefore save a step in an end user's production line. Furthermore, this methodology allows for re-calibration of the accelerometer over time, as needed, and without the user being aware of the re-calibration.

Accordingly, the auto-calibration methodology can improve the measurement accuracy of the accelerometer, by re-calibrating regularly to accommodate for temperature changes and long-term drift effects due to aging.

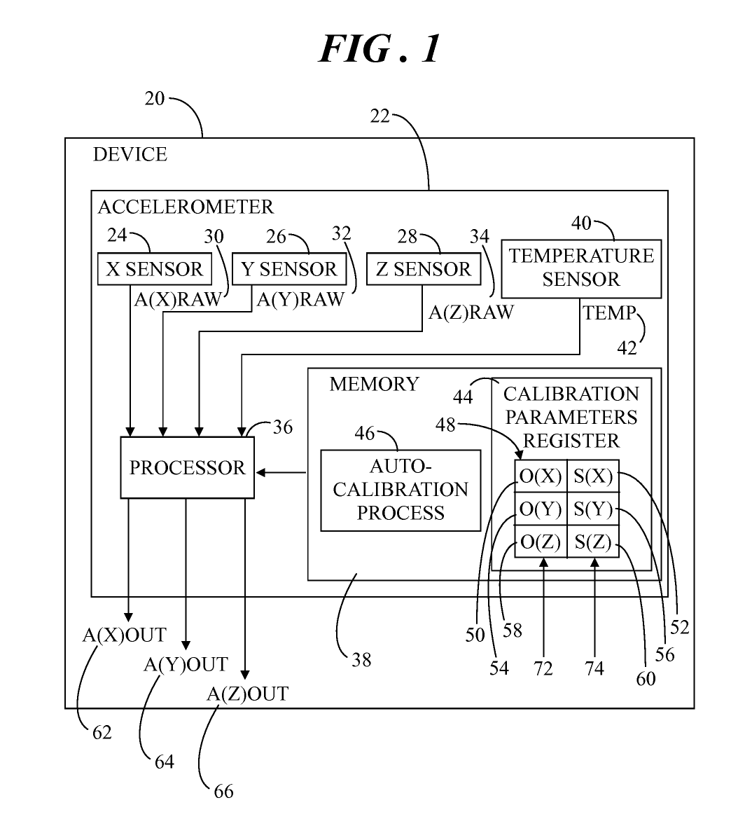

FIG. 1 shows a block diagram of a device 20 having an auto-calibrating accelerometer 22 installed therein in accordance with an embodiment. Device 20 may be any portable electronic device that utilizes an accelerometer to detect the position of the device. Exemplary portable electronic devices include smartphones, digital audio players, and personal digital assistants that contain accelerometers for user interface control. Accelerometer 22 in such devices can be used to detect orientation of the device so as to present landscape or portrait views of the device's screen based on the way the device is being held. However, accelerometer 22 may be used in other types of electronic devices as well. For example, other portable electronic devices include game controllers which contain an accelerometer for motion input, and the like.

Accelerometer 22 includes sense elements for measuring acceleration of device 20 during operational use of device 20. In an embodiment, accelerometer 22 is a three-axis accelerometer capable of sensing acceleration along three orthogonal axes. As such, accelerometer 22 includes a first sense element, referred to herein as an X sensor 24, for sensing acceleration along an X sense axis, a second sense element, referred to herein as a Y sensor 26, for sensing acceleration along a Y sense axis, and a third sense element, referred to herein as a Z sensor 28, for sensing acceleration along a Z sense axis.

Each of X, Y, and Z sensors 24, 26, and 28, respectively, can include a moveable element, commonly referred to as proof mass (not shown), that moves in response to acceleration along its corresponding sense axis. Thus, the proof mass changes its position relative to static sensing electrodes (not shown). This change in position can then be picked up by capacitive, optical, piezoresistive, or tunneling techniques to provide a signal indicative of acceleration. By way of example, X sensor 24 produces a first acceleration output signal, A(X)RAW 30. Y sensor 26 produces a second acceleration output signal, A(Y)RAW 32, and Z sensor 28 produces a third acceleration output signal, A(Z)RAW 34.

The terms “first,” “second,” “third,” and so forth used herein do not refer to an ordering or prioritization of elements within a countable series of elements. Rather, the terms “first,” “second,” “third,” and so forth are used to distinguish the particular elements for clarity of discussion.

Accelerometer 22 further includes a processor 36 in communication with each of X, Y, and Z sensors 24, 26, and 28, respectively, and a memory element 38 in communication with processor 36. In an embodiment, a temperature sensor 40, that produces a temperature signal, TEMP 42, may also be in communication with processor 36.

A calibration parameters register 44 and executable code, in the form of an auto-calibration process 46, may be stored in memory element 38. Current calibration parameters 48 associated with each of X, Y, and Z sensors 24, 26, and 28 are stored in calibration parameters register 44, and auto-calibration process 46 is executed autonomously, i.e., without user or other external intervention, to update current calibration parameters 48 as needed. That is, auto-calibration process 46 is capable of automatically updating the calibration parameters if and when current calibration parameters 48 are no longer accurate enough.

In an embodiment, calibration parameters 48 include offset and sensitivity. In this three-axis accelerometer embodiment, a first offset, O(X) 50, and a first sensitivity, S(X) 52, are associated with X sensor 24. A second offset, O(Y) 54, and a second sensitivity, S(Y) 56, are associated with Y sensor 26. And a third offset, O(Z) 58, and a third sensitivity, S(Z) 60, are associated with Z sensor 28. Calibration parameters 48 are applied to the acceleration output signals, A(X)RAW 30, A(Y)RAW 32, and A(Z)RAW 34 to produce processed accelerometer signals, A(X)OUT 62, A(Y)OUT 64, and A(Z)OUT 66.

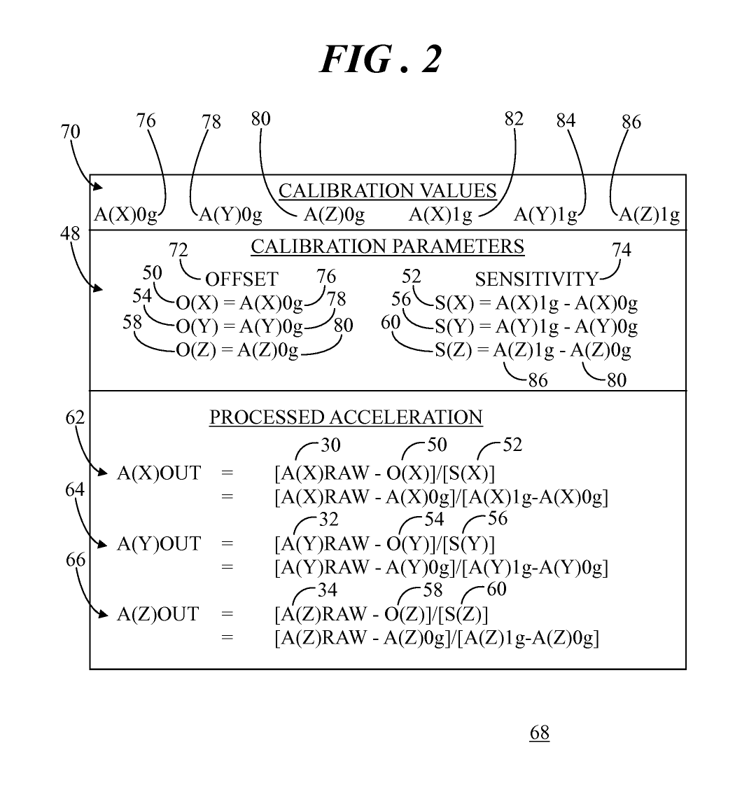

Referring to FIG. 2 in connection with FIG. 1, FIG. 2 shows a diagram 68 of calibration values 70 used to determine calibration parameters 48, and ultimately to produce processed accelerometer signals, A(X)OUT 62, A(Y)OUT 64, and A(Z)OUT 66 for accelerometer 22.

Calibration parameters 48 generally include offset 72 and sensitivity 74. Offset 72, sometimes referred to as the 0g-offset, offset error, or bias error, is defined as the difference between the measured value of the sensor from the true zero value. Sensitivity 74, sometimes referred to as the scale factor of the accelerometer, is defined as the ratio of the sensor's electrical output to mechanical output. Sensitivity 74 of an accelerometer is influenced by offset 72 of an accelerometer. Accordingly, if an offset error is introduced due to device-to-device variation, mechanical stresses, long term drift effect, or offset shift due to temperature, those errors will show up as an error in the acceleration reading, i.e., processed accelerometer signals, A(X)OUT 62, A(Y)OUT 64, and A(Z)OUT 66.

Calibration values 70 represent offset 72 and sensitivity 74. Calibration values 70 include an acceleration offset value at 0g in each of the three orthogonal axes, i.e., A(X)0g 76, A(Y)0g 78, and A(Z)0g 80. In addition, calibration values 70 include an acceleration value at 1g in each of the three orthogonal axes, i.e., A(X)1g 82, A(Y)1g 84, and A(Z)1g 86. In an embodiment, first offset, O(X) 50 is equivalent to acceleration offset value at 0g, A(X)0g 76. Second offset, O(Y) 54, is equivalent to acceleration offset value at 0g, A(Y)0g 78. And third offset, O(Z) 58, is equivalent to acceleration offset value at 0g, A(Z)0g 80. Additionally, first sensitivity, S(X) 52 is equivalent to the difference between acceleration value at 1g, A(X)1g 82, and acceleration offset value at 0g, A(X)0g 76. Second sensitivity, S(Y) 56 is equivalent to the difference between acceleration value at 1g, A(Y)1g 84, and acceleration offset value at 0g, A(Y)0g 78. And third sensitivity, S(Z) 60 is equivalent to the difference between acceleration value at 1g, A(Z)1g 86, and acceleration offset value at 0g, A(Z)0g 80.

Calibration values 70 may initially be set during the manufacture, calibration, and testing of accelerometer 22. These calibration values 70 are used to determine initial values for calibration parameters 48. Calibration parameters 48, i.e., respective offsets 72 and sensitivities 74, are applied to A(X)RAW 30 to produce A(X)OUT 62, are applied to A(Y)RAW 32 to produce A(Y)OUT 64, and are applied to A(Z)RAW 34 to produce A(Z)OUT 66. These initially set calibration parameters 48 may eventually become inaccurate due to, for example, mechanical stresses, long term drift effect, or offset shift due to temperature.

In an embodiment, auto-calibration process 46 solves for six unknown calibration values 70, namely, acceleration offset value at 0g in each of the three orthogonal axes, i.e., A(X)0g 76, A(Y)0g 78, and A(Z)0g 80, and acceleration value at 1g in each of the three orthogonal axes, i.e., A(X)1g 82, A(Y)1g 84, and A(Z)1g 86. These calibration values 70 are used to determine whether current calibration parameters 48 are to be replaced with updated calibration parameters when current calibration parameters 48 are no longer accurate.

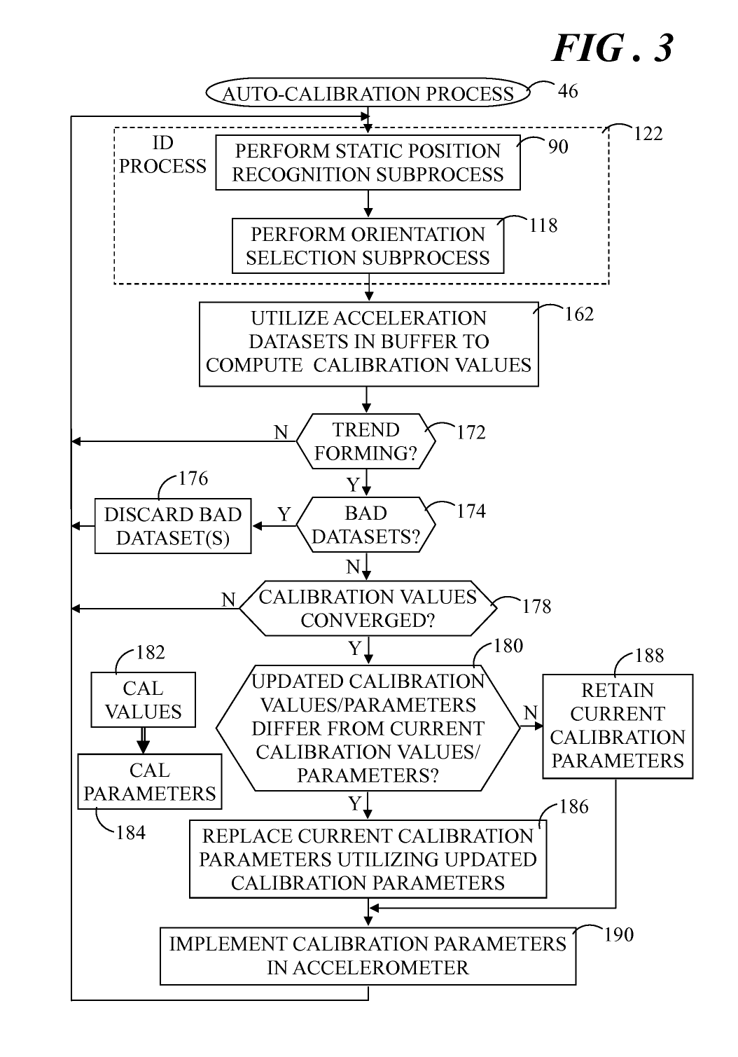

FIG. 3 shows a flowchart of auto-calibration process 46 performed by accelerometer 22. Auto-calibration process 46 is executed by processor 36 (FIG. 1) of accelerometer 22 (FIG. 1) without intervention of a user through intelligent data gathering techniques for handling changes in environmental conditions, temperature, time, and location. The methodology of auto-calibration process 46 calibrates both offset 72 and sensitivity 74 of all axes and accomplishes intelligent data collection in a wide variety of scenarios. The methodology of auto-calibration process 46 does not require previous calibration because it uses delta measurements to establish no motion conditions. In addition, the methodology can identify which data points are valid and which are invalid based on how the system solution changes and converges.

Auto-calibration process 46 can be performed during operational use of device 20 (FIG. 1). Accordingly, auto-calibration process 46 may be initiated upon power up of device 20. Process 46 begins with a task 90. At task 90, a static position recognition subprocess is performed.

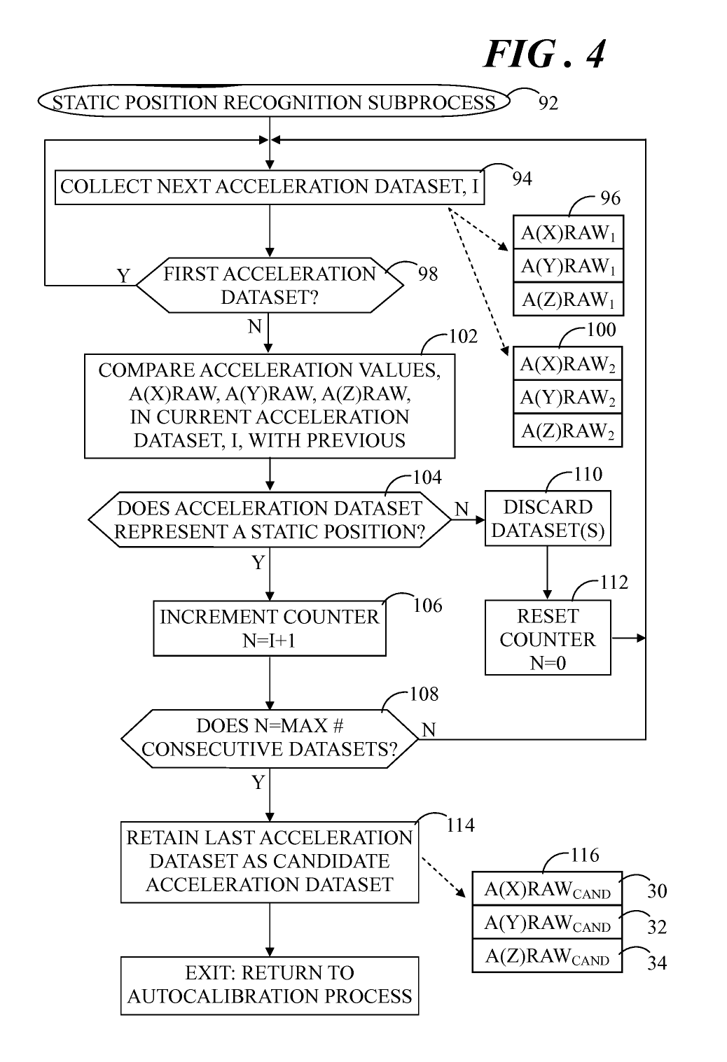

Referring to FIG. 4 in connection with task 90, FIG. 4 shows a flowchart of a static position recognition subprocess 92 implemented within auto-calibration process 46. Static position recognition subprocess 92 is performed to collect an acceleration dataset of values for A(X)RAW 30, A(Y)RAW 32, and A(Y)RAW 34 during a scenario in which device 20, and hence accelerometer 22, is not in motion.

Static position recognition subprocess 92 begins with a task 94. At task 94, a next acceleration dataset, I, is collected. Static position recognition subprocess 92 is an iterative process. Accordingly, during a first iteration of task 94, a “next” acceleration dataset, I, is a first acceleration dataset. An acceleration dataset 96 includes distinct acceleration values for A(X)RAW 30, A(Y)RAW 32, and A(Y)RAW 34.

Following task 94, subprocess 92 continues with a query task 98. At query task 98, a determination is made as to whether the “next” acceleration dataset 96 collected at task 94 is a first acceleration dataset. This condition is met during a first iteration of task 94. When a determination is made at query task 98 that acceleration dataset 96 collected at task 94 is a first acceleration dataset, e.g., I=1, program control loops back to task 94 in order to collect a “next” acceleration dataset, e.g., I=2. When a determination is made at query task 98 that another acceleration dataset 100 has been collected, subprocess 92 continues with a task 102.

For clarity, the earlier collected acceleration dataset 96 will be referred to herein as previous acceleration dataset, 96 and the later collected acceleration dataset 100 will be referred to herein as current acceleration dataset 100. Previous acceleration dataset 96 and current acceleration dataset 100 are consecutive samples, or readings, from accelerometer 22 (FIG. 2)

At task 102, the distinct acceleration values for A(X)RAW 30, A(Y)RAW 32, and A(Y)RAW 34 in current acceleration dataset 100 are compared with the distinct acceleration values for A(X)RAW 30, A(Y)RAW 32, and A(Y)RAW 34 in previous acceleration dataset 96. In an embodiment, the distinct acceleration values for A(X)RAW 30, A(Y)RAW 32, and A(Y)RAW 34 may be output voltages produced by each of X sensor 24, Y sensor 26, and Z sensor 28. A determination of motion versus a static position is made by looking at the difference in values between A(X)RAW 30, A(Y)RAW 32, and A(Y)RAW 34 in current acceleration dataset 100 and A(X)RAW 30, A(Y)RAW 32, and A(Y)RAW 34 in previous acceleration dataset 96. If the differences in values are very close to one another (e.g., the max(abs(A(X)1−A(X)2))<static threshold, the max(abs(A(Y)1−A(Y)2))<static threshold, and the max(abs(A(Z)1−A(Z)2))<static threshold) then current acceleration dataset 110 is considered a “static position dataset.”

A query task 104 is performed in connection with task 102. At query task 104, a determination is made as to whether current acceleration dataset 100 represents a static position dataset. In an example, if the differences in values are very close to one another as determined in comparison task 102, program control continues with a task 106. At task 106, a dataset counter is incremented, e.g., N=I+1. Following task 106, a query task 108 is performed.

At query task 108, a determination is made as to whether a predetermined number of consecutive acceleration datasets have been collected, each representing a “static position dataset,” e.g., N=MAX#. In an embodiment, MAX# can be any desired quantity of consecutive acceleration data sets, each of which meets the static, or non-moving, condition of accelerometer 22 (FIG. 1). By way of example, MAX# may be as low as five for low sampling speeds and approximately one hundred for high sampling speeds. The sampling speed is dependent on what type of application accelerometer 22 is being used for. For illustrative purposes, if accelerometer 22 readings are sampled at one hundred samples per second, and MAX# is set at fifty, than the condition to be satisfied is that of accelerometer 22 being in a static position for half of a second.

When a determination is made at query task 108 that N does not equal MAX#, that is a predetermined of consecutive static position datasets have not been collected, program control loops back to task 94 to collect the “next” consecutive acceleration dataset and perform static position testing. In such an instance, acceleration dataset 100 would now be designated previous acceleration dataset 96, and the “next” consecutive dataset would then be designated current acceleration dataset 100.

Returning to query task 104, when a determination is made that current acceleration dataset 100 does not represent a static position dataset (i.e., accelerometer 22 is in motion), program control proceeds to a task 110. At task 110, any acceleration datasets collected thus far during the current execution of static position recognition subprocess 92 are discarded. In this example, acceleration datasets 96 and 100 would be discarded.

Following task 110, static position recognition subprocess 92 continues with a task 112. At task 112, the dataset counter is reset to zero, e.g., N=0, to reflect discarding of the acceleration datasets. Following task 112, process control loops back to task 94 to collect additional acceleration datasets and perform static position testing.

When a determination is made at query task 108 that N equals MAX#, that is a predetermined number of consecutive static position datasets have now been collected, program control continues with a task 114. At task 114, the last acceleration dataset collected is retained as a candidate acceleration dataset 116 and static position recognition subprocess 92 exits with a return to auto-calibration process 46 (FIG. 3).

Accordingly, successful execution of static position recognition subprocess 92 with a return to auto-calibration process 46 is accomplished when a “MAX#” of consecutive acceleration datasets meets the static position condition. When device 20, and hence accelerometer 22, are in a static position, values for A(X)RAW 30, A(Y)RAW 32, and A(Y)RAW 34 (FIG. 1) in candidate acceleration dataset 116 are a representation of the pitch and roll (i.e., inclination angles) of device 20, and acceleration in the static position is only a result of the gravity vector projected onto each of the three axes. Once “MAX#” of consecutive acceleration datasets, the values for A(X)RAW_{CAND} 30, A(Y)RAW_{CAND} 32, and A(Y)RAW_{CAND} 34 (FIG. 1) of candidate acceleration dataset 116 are retained for further testing in accordance with auto-calibration process 46.

With reference back to FIG. 3, following task 90 at which static position recognition subprocess 92 is executed, auto-calibration process 46 continues with a task 118 using candidate acceleration dataset 116 (FIG. 4). At task 118, an orientation selection subprocess is performed.

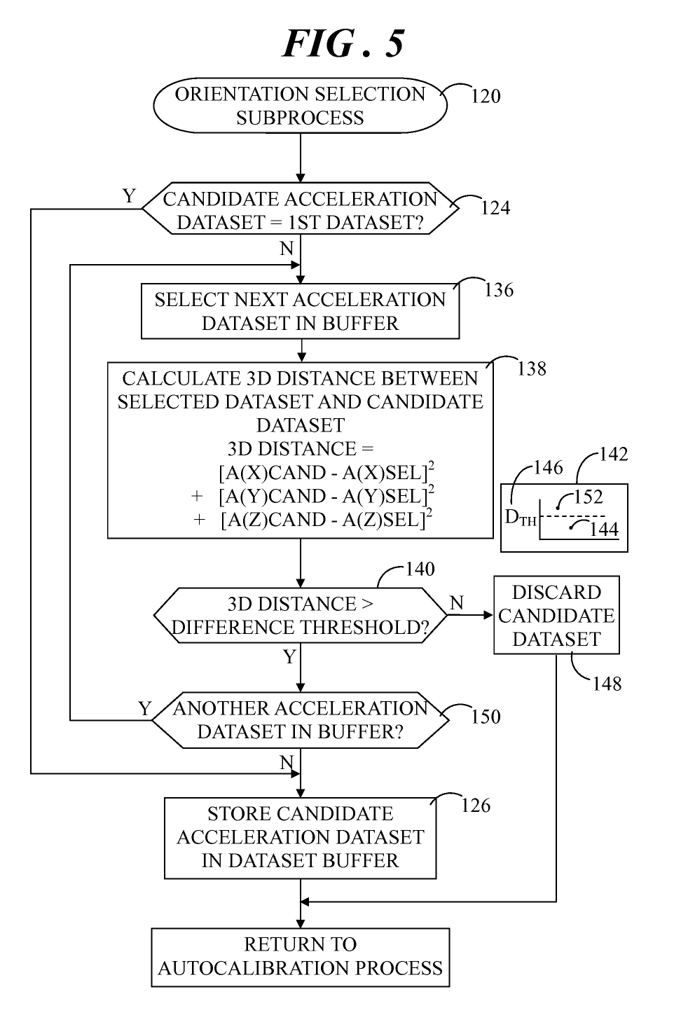

Referring to FIG. 5 in connection with task 118, FIG. 5 shows a flowchart of an orientation selection subprocess 120 implemented within the auto-calibration process 46. Orientation selection subprocess 120 is performed in order to select acceleration datasets from candidate datasets 116 that represent a variety of orientations of accelerometer 22 in which accelerometer 22 is located in a static position. Accordingly, an iterative execution of tasks 90 and 118 represents an identification process 122 for identifying a subset of acceleration datasets, from the plurality that are initially collected, that represents accelerometer 22 in a variety of orientations while additionally in a non-moving state. This subset of acceleration datasets is stored in a buffer and is subsequently utilized to compute updated calibration parameters 48 (FIG. 1).

Orientation selection subprocess 120 begins with a query task 124. At query task 124, a determination is made as to whether candidate acceleration dataset 116 (FIG. 4) produced through execution of static position recognition subprocess 92 (FIG. 4) is a first candidate acceleration dataset. When a determination is made at query task 124 that candidate acceleration dataset 116 is a first acceleration dataset, orientation selection subprocess 120 proceeds to a task 126. At task 126, candidate acceleration dataset 116, as a first acceleration dataset, is stored in a dataset buffer. Following task 126, orientation selection subprocess 120 exits with a return to auto-calibration process 46 (FIG. 3).

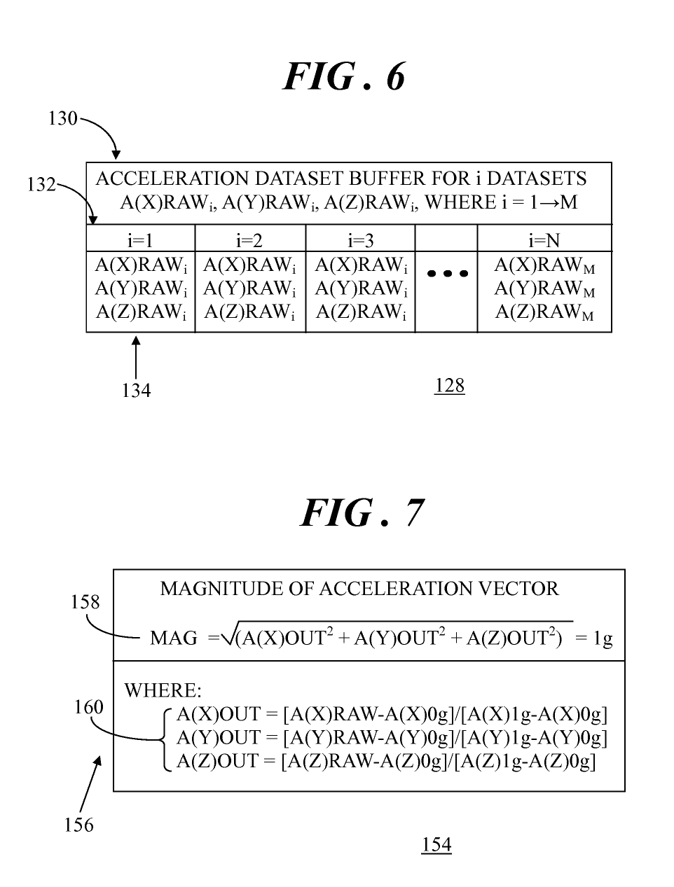

Referring to FIG. 6 in connection with task 126, FIG. 6 shows a table 128 of an exemplary acceleration dataset buffer 130. For illustrative purposes, acceleration dataset buffer 130 includes a number of acceleration datasets 132. Acceleration datasets 132 in buffer 130 are a subset of a plurality of acceleration datasets collected during iterative execution of tasks 90 and 118 that represent a variety of orientations (i.e., inclination angles) of accelerometer 22 that also satisfy the test of static, or non-moving, position. Accordingly, acceleration values in the static position are only a result of the gravity vector projected onto each of the three axes. Acceleration datasets 132 in buffer 130 can be used to update calibration parameters 48 (FIG. 1).

Each of acceleration datasets 132 includes acceleration values for A(X)RAW 30, A(Y)RAW 32, and A(Z)RAW 34. Acceleration dataset buffer 130 includes a first acceleration dataset 134 stored in buffer 130 during a first iteration of task 126. In accordance with an iterative execution of orientation selection subprocess 120, dataset buffer 130 can be populated until a quantity of acceleration datasets 132 stored in buffer 130 reaches a predetermined quantity, i.e., M.

With continued reference to FIGS. 5 and 6, during execution of orientation selection subprocess 120, when a determination is made at query task 124 that candidate acceleration dataset 116 (FIG. 4) is not first acceleration dataset 134, orientation selection subprocess 120 continues with a task 136. That is, a negative response to query task 124 indicates that buffer 130 (FIG. 6) has been populated with at least one acceleration dataset 134.

At task 136, a next acceleration dataset 134 is selected from buffer 130. For illustrative purposes, first acceleration dataset 134 is selected from buffer 130 at task 136.

Next a task 138 is performed. At task 138, a three dimensional (3D) distance is calculated between candidate acceleration dataset 116 (FIG. 4) and the acceleration dataset selected from buffer 130, for example, first acceleration dataset 134. The calculated 3D distance provides an estimate on how far apart candidate acceleration dataset 116 is from first acceleration dataset 134. That is the 3D distance is used to determine whether the orientation of accelerometer 22 represented by candidate acceleration dataset 116 is “different enough” from the orientation of accelerometer 22 represented by first acceleration dataset 134. In an embodiment, 3D distance is calculated as [A(X)CAND−A(X)SEL]²+[A(Y)CAND−A(Y)SEL]+[A(Z)CAND−A(Z)SEL]², where CAND represents raw acceleration values for candidate acceleration dataset 116 and SEL represents raw acceleration values for the dataset selected from buffer 130, e.g., first acceleration dataset.

Although 3D distance methodology is discussed herein, it should be understood that alternative methodologies may be implemented for determining whether candidate acceleration dataset 116 is “different enough” from those in buffer 130. For example, if the raw acceleration value, A(X)CAND, for candidate acceleration dataset 116 differs from each acceleration value, A(X), in buffer 130, that might be enough for determining that candidate acceleration dataset 116 is “different enough” from those in buffer 130. Similarly, a determination may be made that candidate acceleration dataset 116 is “different enough” from those in buffer 130 if A(Y)CAND or A(Z)CAND, or any logical combination of A(X)CAND, A(Y)CAND, and A(Z)CAND for candidate acceleration dataset 116 differ from each corresponding acceleration value, A(X), A(Y), and A(Z), in buffer 130. In another embodiment, a determination may be ascertained of which location on a sphere is represented by candidate acceleration dataset 116 and spreading those locations on the hypothetical sphere. Still in another embodiment, a different formula could be used to calculate the “3D distance” between candidate acceleration datasets and those datasets currently stored in buffer 130.

A query task 140 is performed in connection with task 138. At query task 140, a determination is made as to whether the calculated 3D distance is greater than a difference threshold. The difference threshold provides a parameter indicating that the deviation in orientation of accelerometer represented by candidate acceleration dataset 116 is “different enough” from the orientation of accelerometer 22 represented by first acceleration dataset 134.

A chart 142 is provided in FIG. 5 for exemplary purposes showing a first data point 144 representing a calculated 3D distance that is not greater than a difference threshold 146. When a determination is made at query task 140 that 3D distance 144 is less than difference threshold 146, program control proceeds to a task 148. At task 148, candidate acceleration dataset 116 is discarded because it is not “different enough” from at least one of acceleration datasets 132. Following task 148, orientation selection subprocess 120 exits with a return to auto-calibration process 46 (FIG. 3). Alternatively, when a determination is made at query task 140 that the 3D distance is greater than difference threshold 146, orientation selection subprocess 120 continues with a query task 150. Again, for exemplary purposes, chart 142 additionally shows a second data point 152 representing a calculated 3D distance that is greater than difference threshold 146.

At query task 150, a determination is made as to whether another acceleration dataset 132 is currently stored in dataset buffer 130. When there is another acceleration dataset 132 is buffer 130, program control loops back to task 136 to select the next acceleration dataset 132 from buffer 130 and perform the subsequent 3D distance calculation (task 138) and test whether candidate acceleration dataset 116 (FIG. 4) is “different enough” from the next acceleration dataset 132 already stored in buffer 130. Thus, the iterative execution of tasks 136, 138, 140, and 150 enables acceleration values within candidate acceleration dataset 116 to be compared with the acceleration values within each of acceleration datasets 132 to verify that candidate acceleration dataset 116 is significantly different from all previous acceleration datasets 132 stored in buffer 130. When a determination is eventually made at query task 150 that candidate acceleration dataset 116 has been compared with all previous acceleration datasets 132 stored in buffer 130 and is significantly different, subprocess 120 continues with task 126.

At task 126, candidate acceleration dataset 116 is stored in dataset buffer 130 as one of acceleration datasets 132. That is, candidate acceleration dataset 116 satisfies the conditions of either being the first acceleration dataset to be stored in dataset buffer 130 or of being different enough from all previous acceleration datasets 132 currently stored in dataset buffer 130 and of being in a static, non-moving position. Following task 126, orientation selection subprocess 120 exits with a return to auto-calibration process 46 (FIG. 3).

Referring back to FIG. 3, as a result of execution of identification process 122, which includes static position recognition subprocess 92 (FIG. 4) and orientation selection subprocess 120 (FIG. 5), each of acceleration datasets 132 stored in dataset buffer 130 should satisfy a condition in which the magnitude of the acceleration vector for a static object is always 1g regardless of orientation (inclination) of accelerometer 22.

FIG. 7 shows a diagram 154 of equations 156 for computing a magnitude of acceleration vector 158. Magnitude of acceleration vector 158 is defined as the square root of processed acceleration signals 160, where a processed acceleration signal, e.g., A(X)OUT, is equivalent to the difference between the raw acceleration signal, e.g. A(X)RAW, and the acceleration offset value at 0g, e.g., A(X)0g. And this difference is divided by the difference between the acceleration value at 1g, e.g., A(X)1g and the acceleration offset value at 0g, e.g., A(X)0g. In other words, the three equations 158 establish a relationship between the six unknown acceleration values 70, namely, acceleration offset value at 0g in each of the three orthogonal axes, i.e., A(X)0g 76, A(Y)0g 78, and A(Z)0g 80, and acceleration value at 1g in each of the three orthogonal axes, i.e., A(X)1g 82, A(Y)1g 84, and A(Z)1g 86 (FIG. 2). Each acceleration dataset 132 (FIG. 6) provides the raw acceleration signals, e.g., A(X)RAW 30, A(Y)RAW 32, and A(Y)RAW 34 (FIG. 1).

Referring back to FIG. 3, following task 118 of auto-calibration process 46 in which orientation selection subprocess 120 (FIG. 5) is performed, auto-calibration process 46 continues with a task 162. At task 162, a subset of acceleration datasets that were collected (e.g., acceleration datasets 132 up to the predetermined quantity, M that are currently stored in buffer 130) are utilized to compute calibration values 70 (FIG. 2). As discussed previously, calibration values 70 include six unknowns, namely, acceleration offset value at 0g in each of the three orthogonal axes, i.e., A(X)0g 76, A(Y)0g 78, and A(Z)0g 80, and acceleration value at 1g in each of the three orthogonal axes, i.e., A(X)1g 82, A(Y)1g 84, and A(Z)1g 86 (FIG. 2).

This computation is performed utilizing equations 156 (FIG. 7) and the condition that magnitude of the acceleration vector 158 for a static object is 1g in order to obtain the six unknown calibration values 70. At task 162, attempts to solve equations 158 in order to obtain calibration values 70. Given, however, that this is empirical data, equations 158 cannot actually be solved. Rather, a parameter estimation algorithm may be utilized to find a “best fit.” By way of example, a best fit may be found by looking at how much error (i.e., deviation from a perfect 1g solution) different sets of estimated parameters, i.e., calibration values 70 create. The best set of calibration values 70, with the lowest resulting error, is selected.

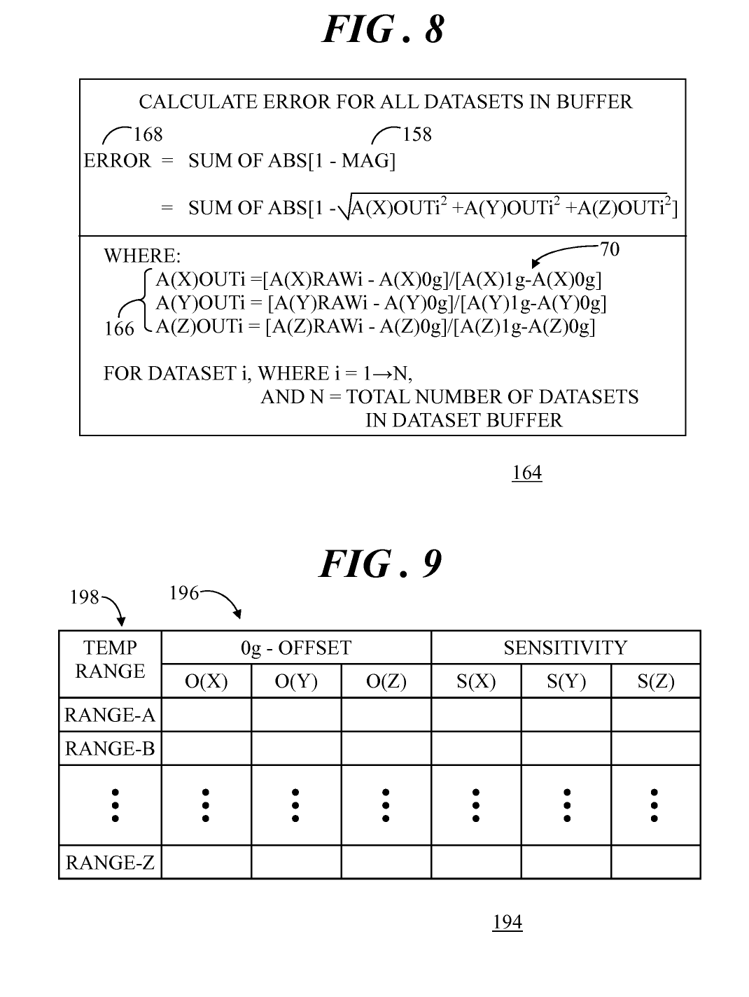

Referring to FIG. 8 in connection with task 162, FIG. 8 shows a diagram 164 of equations 166 for computing the resulting error of a set of estimated parameters, i.e., calibration values 70. As represented in diagram 164, an error value 168 may be calculated for all acceleration datasets 132 (FIG. 6) currently stored in dataset buffer 130 (FIG. 6), i.e., datasets i through N. Error value 168 is defined as the SUM OF ABS of 1 minus magnitude of acceleration vector 158. Parameter estimation and error computation are discussed in general terms herein. Those skilled in the art will readily recognize that there are several different methodologies for performing parameter estimation and error computation.

With reference back to FIG. 3, a query task 172 is performed in response to task 162. At query task 172, auto-calibration process 46 makes a determination as to whether a trend is developing in the estimated calibration values 70 for acceleration datasets 132 currently in dataset buffer 130 that were computed at task 162. A trend may be the general drift, tendency, or bent of a set of the estimated parameters, i.e., calibration values 70, as related to the other related sets of estimated parameters, i.e., calibration values 70. When a determination is made at query task 172 that a trend is not forming in the estimated calibration values 70, process control loops back to task 90 to identify and select additional acceleration datasets 132 (FIG. 6) for inclusion in dataset buffer 130 (FIG. 6). However, when a determination is made at query task 172 that a trend is forming in the estimated calibration values, auto-calibration process continues with a task 174.

At query task 174, a determination is made as to whether any of acceleration datasets 132 in dataset buffer 130 represent “bad data.” In an embodiment, acceleration datasets 132 that represent “bad data” may have a computed error value 168 (FIG. 8) that is the highest or is more than twice the average error. Other embodiments may utilize different criteria for identifying acceleration datasets 132 in dataset buffer 130 that represent “bad data.” When query task 174 determines that at least one of acceleration datasets in dataset buffer 130 represent “bad data,” process control proceeds to a task 176.

At task 176, the identified acceleration datasets 132 that represent “bad data” are discarded from buffer 130. Following task 176, process 46 loops back to task 90 to continue populating dataset buffer 130 with acceleration datasets 132. The systematic elimination of identified acceleration datasets 132 that represent “bad data” enables the replacement of “bad data” with new acceleration datasets 132 so as to enable calibration values 70 to converge to tighter values.

When a determination is made at query task 174 that none of acceleration datasets 132 in dataset buffer 130 represent “bad data,” auto-calibration process 46 continues with a query task 178. At query task 178, a determination is made as to whether calibration values 70 estimated at task 162 have converged to clearly established values. In an embodiment, once calibration values 70 are determined for acceleration datasets 132 in the current dataset buffer 130, these calibration values 70 can be compared with calibration values 70 found in the previous acceleration datasets 132 in a previous dataset buffer 130, i.e., in the immediately prior iteration of task 162.

When calibration values 70 have not yet converged at query task 178, program control loops back to task 90 to continue populating dataset buffer 130 with acceleration datasets 132, and to perform the above described parameter estimation to find updated calibration values 70. Thus, auto-calibration process 46 implements an iterative algorithm in which all of the acceleration datasets 132 in buffer 130 are used at each iterative computation (at each iteration), and thus can produce highly accurate parameter estimation. That is, the parameter estimates relying on unknown variables are computed by using the estimates of these unknown variables which are obtained from the preceding parameter estimates.

When calibration values 70 are determined to have converged at query task 178, auto-calibration process 46 continues with a query task 180. The resulting product of the above described process is a set of updated calibration values 182 for the six unknowns, i.e., acceleration offset value at 0g in each of the three orthogonal axes, i.e., A(X)0g 76, A(Y)0g 78, and A(Z)0g 80, and acceleration value at 1g in each of the three orthogonal axes, i.e., A(X)1g 82, A(Y)1g 84, and A(Z)1g 86. Updated calibration parameters 184 can be readily ascertained from updated calibration values 182, as discussed above in connection with FIG. 2.

At query task 180, a comparison may be made between updated calibration values 182 and current calibration values 70 (FIG. 2). Alternatively, a comparison may be made between updated calibration parameters 184 and current calibration parameters 48 (FIG. 2). When a determination is made at query task 180 that updated calibration values 182 (or alternatively, updated calibration parameters 184) differ from current calibration values 70 (or alternatively, current calibration parameters 48) a conclusion is made that current values 70/parameters 48 are no longer accurate. In such an instance, auto-calibration process 46 continues with a task 186.

At task 186, current calibration parameters 48 in calibration parameters register 44 (FIG. 1) are replaced by updated calibration values 182.

However, when a determination is made at query task 180 that updated calibration values 182 (or alternatively, updated calibration parameters 184) do not differ significantly from current calibration values 70 (or alternatively, current calibration parameters 48) a conclusion is made that current values 70/parameters 48 remain accurate. In such an instance, auto-calibration process 46 continues with a task 188.

At task 188, current calibration parameters 48 are retained in calibration parameters register 44.

Following either of tasks 186 and 188, a task 190 is performed. At task 190, the calibration parameters stored in calibration parameters register 44 are implemented in accelerometer 22 (FIG. 1). More particularly, following task 186, updated calibration parameters 184 now stored in calibration parameters register 44 are implemented and following task 188, current calibration parameters 48 retained in calibration parameters register 44 are implemented Implementation calls for applying respective offsets O(X) 50, O(Y) 54, and O(Z) 56 as well as respective sensitivities S(X) 52, S(Y) 56, and S(Z) 60 to corresponding acceleration output signals A(X)RAW 30, A(Y)RAW 32, and A(Z)RAW 34 to obtain processed accelerometer signals A(X)OUT 62, A(Y)OUT 62, and A(Z)OUT 64.

In response to task 190, auto-calibration process 46 loops back to task 90 to repeat the above described methodology in order to adjust the calibration parameters in calibration parameters register 44 if and when these calibration parameters are no longer accurate. The above methodology is recursive so that a “temporary solution” for calibration parameters 48 is continually computed in order to determine offset 72 (FIG. 1) and sensitivity 74. In addition, since calibration parameters 48 are being continually computed the process also adapts to changes in temperature and thus creates an automatic temperature compensation scheme. That is, when the operational temperature changes, offset 72 and sensitivity 74 can change so that updated calibration parameters adapt to the changing temperature.

FIG. 9 shows a table 194 of calibration parameters 196 associated with particular operational temperature ranges 198 for accelerometer 22 in accordance with an alternative embodiment. As mentioned above, accelerometer can include temperature sensor 40 (FIG. 1) that produces a temperature signal, TEMP 42, that is communicated to processor 36 (FIG. 1). As an adjunct to auto-calibration process 46, particular acceleration datasets 132 (FIG. 6) may be stored in dataset buffer 130 (FIG. 6) along with a particular received temperature characteristic, e.g., TEMP 42. Accordingly, calibration parameters 196 may be updated and associated with particular operational temperature ranges 198. Thus, a temperature compensation curve for offset 72 and a temperature compensation curve for sensitivity 74 (not shown) can be produced. With such temperature compensation information, even if valid acceleration datasets 132 (i.e., not moving and representing a variety of orientations) are not currently being received, temperature compensation can still be performed.

In summary, embodiments of the present disclosure entail an accelerometer capable of auto-calibration and a method performed by the accelerometer for updating calibration parameters of the accelerometer. The auto-calibration capability implements intelligent data gathering techniques in order to adjust calibration parameters on all axes and on an as needed basis to compensate for changes in environmental conditions, temperature, time, and location. Furthermore, the auto-calibration capability does not require previous calibration, as it uses delta measurements to establish non-moving, i.e., static, conditions. It can additionally identify which data points are valid and which data points are invalid based on how the system solution changes and converges, and based on knowledge of the data inputs and how those data inputs are collected. Since the calibration parameters include both offset and sensitivity, temperature sensing can be added so that offset and sensitivity calibration parameters can be adjusted in accordance with temperature change. Accordingly, the auto-calibration capability can improve the measurement accuracy of an accelerometer by re-calibrating regularly, without the user being aware of the re-calibration, to accommodate for temperature changes and long-term drift effects due to aging.

Although embodiments have been illustrated and described in detail, it will be readily apparent to those skilled in the art that various modifications may be made therein without departing from the spirit of the invention or from the scope of the appended claims. For example, the process steps discussed herein can take on great number of variations and can be performed in a differing order then that which was presented. In addition, the process steps can be adapted for auto-calibration of a single-axis or dual-axis accelerometer.

What is claimed is:

1. A method of calibrating an accelerometer comprising:
collecting a plurality of acceleration datasets from said accelerometer;
identifying a subset of acceleration datasets from said plurality of acceleration datasets in which each of said acceleration datasets in said subset represents a scenario in which said accelerometer is located in a static position;
utilizing said subset of acceleration datasets to compute updated calibration parameters;
comparing current calibration parameters for said accelerometer to said updated calibration parameters to determine a validity of said current calibration parameters;
when said current calibration parameters are invalid, replacing said current calibration parameters with said updated calibration parameters; and
implementing said updated calibration parameters in said accelerometer.

2. A method as claimed in claim 1 wherein said accelerometer is installed within a device, and said method further comprises automatically performing said collecting operation when said device is in operational use.

3. A method as claimed in claim 1 wherein:
said collecting operation comprises collecting consecutive ones of said acceleration datasets; and
said identifying operation comprises:
determining that a predetermined quantity of said consecutive ones of said acceleration datasets represents said scenario in which said accelerometer is in said static position; and
including one of said consecutive acceleration datasets in said subset of acceleration datasets in response to said determining operation.

4. A method as claimed in claim 3 wherein:
said determining operation comprises comparing acceleration values within each of said consecutive acceleration datasets with said acceleration values within at least another one of said consecutive acceleration datasets;
when said acceleration values within said each of said consecutive acceleration datasets are approximately equivalent, said including operation retains said one of said consecutive acceleration datasets in said subset of acceleration datasets; and
when said acceleration values within said each of said consecutive acceleration datasets fail to be approximately equivalent, discarding said each of said consecutive acceleration datasets.

5. A method as claimed in claim 1 wherein said identifying operation comprises:
distinguishing those of said acceleration datasets in said plurality of acceleration datasets that represent a second scenario in which said accelerometer is in motion; and
discarding said distinguished acceleration datasets that represent said second scenario.

6. A method as claimed in claim 1 wherein said identifying operation comprises selecting said acceleration datasets for inclusion in said subset of said acceleration datasets that represent a variety of orientations of said accelerometer in said static position.

7. A method as claimed in claim 6 wherein said selecting operation comprises:
identifying a candidate acceleration dataset from said plurality of acceleration datasets for inclusion in said subset of acceleration datasets;
comparing acceleration values within said candidate acceleration dataset with said acceleration values within said acceleration datasets in said subset;
when a difference between said acceleration values within said candidate acceleration dataset and said acceleration values within said acceleration datasets in said subset is greater than a deviation threshold, retaining said candidate acceleration dataset in said subset of datasets; and
when said difference between said acceleration values within said candidate acceleration dataset and said acceleration values within said acceleration datasets in said subset is less than said deviation threshold, discarding said each acceleration dataset from said subset.

8. A method as claimed in claim 1 further comprising:
repeating said collecting and identifying operations until a quantity of said acceleration datasets in said subset is at least equivalent to a predetermined quantity; and
performing said utilizing operation for each repetition of said identifying operation.

9. A method as claimed in claim 1 wherein said updated calibration parameters include at least one offset value and at least one sensitivity value associated with at least one sense axis of said accelerometer, and said utilizing operation comprises determining said at least one offset value and said at least one sensitivity value using a parameter estimation algorithm.

10. A method as claimed in claim 9 wherein said implementing operation comprises combining said at least one offset value and said at least one sensitivity value with output signals of said accelerometer to calibrate said accelerometer.

11. A method as claimed in claim 1 further comprising:
receiving a temperature characteristic of said accelerometer concurrent with collecting each of said plurality of acceleration datasets;
associating said temperature characteristic with said each of said plurality of acceleration datasets; and
selecting said acceleration datasets for inclusion in said subset of said acceleration datasets, each of which is associated with said temperature characteristic for said accelerometer in said static position.

12. A method as claimed in claim 11 further comprising:
performing said utilizing operation to compute said updated calibration parameters using said subset of said acceleration datasets, each of which is associated with said temperature characteristic;
following said utilizing operation, storing said updated calibration parameters in association with said temperature characteristic; and
said implementing operation comprises applying said updated calibration parameters when said accelerometer operates in a temperature range associated with said temperature characteristic.

13. A device comprising:
an accelerometer for measuring acceleration of said device during operational use of said device, said accelerometer comprising:
at least one sense element capable of sensing an acceleration value along a sense axis;
a processor in communication with said at least one sense element; and
a memory element in communication with said processor for storing current calibration parameters associated with said at least one sense element, said memory element having executable code stored therein, said executable code instructing said processor to perform operations comprising:
automatically collecting a plurality of acceleration datasets from said at least one sense element during operational use of said device;
identifying a subset of acceleration datasets from said plurality of acceleration datasets in which each of said acceleration datasets in said subset represents a scenario in which said accelerometer is located in a static position, said identifying operation including selecting said acceleration datasets for inclusion in said subset that represent a variety of orientations of said accelerometer in said static position;
utilizing said subset of acceleration datasets to compute updated calibration parameters;
comparing current calibration parameters for said accelerometer to said updated calibration parameters to determine a validity of said current calibration parameters;
when said current calibration parameters are invalid, replacing said current calibration parameters with said updated calibration parameters; and
implementing said updated calibration parameters in said accelerometer.

14. A device as claimed in claim 13 wherein said executable code instructs said processor to perform further operations wherein:
said collecting operation includes collecting consecutive ones of said acceleration datasets; and
said identifying operation includes:
determining that a predetermined quantity of said consecutive ones of said acceleration datasets represents said scenario in which said accelerometer is in said static position; and
including one of said consecutive acceleration datasets in said subset of acceleration datasets in response to said determining operation.

15. A device as claimed in claim 14 wherein said executable code instructs said processor to perform further operations wherein:
said determining operation comprises comparing acceleration values within each of said consecutive acceleration datasets with said acceleration values within at least another one of said consecutive acceleration datasets;
when said acceleration values within said each of said consecutive acceleration datasets are approximately equivalent, said including operation retains said one of said consecutive acceleration datasets in said subset of acceleration datasets; and
when said acceleration values within said each of said consecutive acceleration datasets fail to be approximately equivalent, discarding said each of said consecutive acceleration datasets.

16. A device as claimed in claim 13 wherein said executable code instructs said processor to perform further operations comprising:
repeating said collecting and identifying operations until a quantity of said acceleration datasets in said subset is at least equivalent to a predetermined quantity; and
performing said utilizing operation for each repetition of said identifying operation.

17. A device as claimed in claim 13 wherein said accelerometer further comprises at least one output in communication with said processor for output of a processed acceleration signal, said updated calibration parameters being combined with said acceleration value from said at least one sense element to produce said processed acceleration signal.

18. A device as claimed in claim 13 wherein said at least one sense element is a first sense element, said calibration parameters include at least one offset value and at least one sensitivity value, and said accelerometer further comprises:
a second sense element in communication with said processor; and
a third sense element in communication with said processor, said first, second, and third sense elements having respective first, second, and third sense axes arranged orthogonal to one another, and said executable code instructs processor to perform an operation comprising executing a parameter estimation algorithm to determine a distinct offset value and a distinct sensitivity value for each of said first, second, and third sense elements.

19. An accelerometer capable of autonomous calibration when said accelerometer is in operational use, said accelerometer comprising:
a first sense element capable of sensing a first acceleration value along a first sense axis;
a second sense element capable of sensing a second acceleration value along a second sense axis;
a third sense element capable of sensing a third acceleration value along a third sense axis, said first, second, and third sense axes being arranged orthogonal to one another;
a processor in communication with said first, second, and third sense elements; and
a memory element in communication with said processor for storing distinct calibration parameters associated with each of said first, second, and third sense elements, said memory element having executable code stored therein, said executable code instructing said processor to perform operations comprising:
collecting a plurality of acceleration datasets from said first, second, and third sense elements;
identifying a subset of acceleration datasets from said plurality of acceleration datasets in which each of said acceleration datasets in said subset represents a scenario in which said accelerometer is located in a static position, said identifying operation including selecting said acceleration datasets for inclusion in said subset that represent a variety of orientations of said accelerometer in said static position;
utilizing said subset of acceleration datasets to compute updated calibration parameters;
comparing current calibration parameters for said accelerometer to said updated calibration parameters;
when said current calibration parameters are invalid, replacing said current calibration parameters stored in said memory element with said updated calibration parameters; and
combining said updated calibration parameters with output acceleration signals from said first, second, and third sense elements to produce calibrated acceleration values for each of said first, second, and third sense axes.

20. An accelerometer as claimed in claim 19 wherein said accelerometer further comprises a temperature sensor in communication with said processor, and said executable code instructs said processor to perform operations comprising:
receiving a temperature characteristic from said temperature sensor concurrent with collecting each of said plurality of acceleration datasets;
associating said temperature characteristic with said each of said plurality of acceleration datasets;
selecting said acceleration datasets for inclusion in said subset of said acceleration datasets, each of which is associated with said temperature characteristic for said accelerometer in said static position;
performing said utilizing operation to compute said updated calibration parameters using said subset of said acceleration datasets, each of which is associated with said temperature characteristic;
following said utilizing operation, storing said updated calibration parameters in said memory element in association with said temperature characteristic; and
said combining operation includes applying said updated calibration parameters when said accelerometer operates in a temperature range associated with said temperature characteristic.
